(19) United States
(12) Patent Application Publication
(10) Pub. No.: US 2025/0079946 A1
(43) Pub. Date: Mar. 6, 2025

(54) ROTARY ACTUATOR

(71) Applicant: NIDEC PRECISION CORPORATION, Tokyo (JP)

(72) Inventors: Yoshihide TONOGAI, Tokyo (JP); Qiang CHEN, Shanghai (CN); Caiwen CHEN, Shanghai (CN)

(21) Appl. No.: 18/814,591

(22) Filed: Aug. 26, 2024

(30) Foreign Application Priority Data
Aug. 28, 2023 (JP) 2023-137932

(51) Int. Cl. H02K 11/20; H02K 37/00

(52) U.S. Cl. CPC H02K 11/20; H02K 37/00

(57) ABSTRACT

To have high maintainability, a rotary actuator includes a groove on a second ring surface being a facing portion of a base facing a rotary member and extending in the rotation direction of the rotary member, a spherical member on a rear surface being a facing portion of the rotary member facing the base and movable in the groove in response to the rotary member rotating relative to the base, and first and second detection switches adjacent to two longitudinal ends of the groove and operable by the spherical member. A control unit causes the rotary member to rotate relative to the base periodically and causes the spherical member to press the first or second detection switch to correct the angle position of a stepper motor to a normal position.

### RELATED APPLICATIONS

The present application claims priority to Japanese Application Number 2023-137932, filed Aug. 28, 2023, the disclosure of which is hereby incorporated by reference herein in its entirety.

### BACKGROUND

### Technical Field

The present invention relates to a rotary actuator for rotating a driving target.

### Description of the Background

For example, Patent Literature 1 describes a network device including a driver that rotates a signal reception antenna. The driver includes a reducer including a drive motor and multiple gears, and is accommodated in a base. A bracket supporting the signal reception antenna is connected to the base in a rotatable manner. The network device further includes a main controller. The main controller controls the drive motor to rotate the signal reception antenna (bracket) to be directed toward a higher signal strength.

### CITATION LIST

### Patent Literature

Patent Literature 1: Japanese Unexamined Patent Application Publication (Translation of PCT Application) No. 2023-508219

### BRIEF SUMMARY

The technique described in Patent Literature 1 uses a position detector including a Hall sensor and a magnetic member to detect the rotation angle of the bracket relative to the base. The main controller may fail to receive pulse signals from the Hall sensor and miscount the pulse signals. This may cause an error in the rotation angle of the bracket relative to the base in the rotation control. In this case, maintenance is to be performed to match the count value of the pulse signals with the rotation angle of the bracket relative to the base.

One or more aspects of the present invention are directed to a rotary actuator with improved maintainability.

A rotary actuator according to one aspect of the present invention includes a base, a rotary member, an electric motor, a groove, a piece, and rotation detection switches. The rotary member is supported by the base in a rotatable manner. The electric motor rotates the rotary member. The groove is on a facing portion of the base. The facing portion faces the rotary member. The groove extends in a rotation direction of the rotary member. The piece is on a facing portion of the rotary member. The facing portion faces the base. The piece is movable in the groove in response to the rotary member rotating relative to the base. The rotation detection switches are located adjacent to two longitudinal ends of the groove. The rotation detection switches are operable by the piece.

The rotary actuator according to the above aspect of the present invention has high maintainability.

### BRIEF DESCRIPTION OF DRAWINGS

FIG. 1 is a perspective view of a rotary actuator according to a first embodiment.

FIG. 2 is an exploded perspective view of the rotary actuator in FIG. 1.

FIG. 3 is a plan view of the rotary actuator in FIG. 1 as viewed from a rotary member (dashed line).

FIG. 4 is a cross-sectional view taken along line A-A in FIG. 3.

FIG. 5 is an enlarged view of part B indicated by the dashed circle in FIG. 4.

FIG. 6 is an exploded perspective view of a ring and a switch substrate.

FIG. 7 is an exploded perspective view of a base and the ring.

FIG. 8 is a perspective view of the rotary member as viewed from the base.

FIG. 9 is a partially enlarged view of the rotary actuator in FIG. 1 describing the movement of a spherical member (at different angles).

FIG. 10 is an exploded perspective view of a rotary actuator according to a second embodiment (with no rotary member shown).

FIG. 11 is an enlarged plan view of portions corresponding to a first switch substrate and a second switch substrate in the rotary actuator in FIG. 10 (with no rotary member shown).

FIG. 12 is an enlarged perspective view of the rotary member in FIG. 10 describing positional adjustment of the first switch substrate and the second switch substrate relative to the ring.

### DETAILED DESCRIPTION

One or more embodiments of the present invention will now be described in detail with reference to the drawings.

### First Embodiment

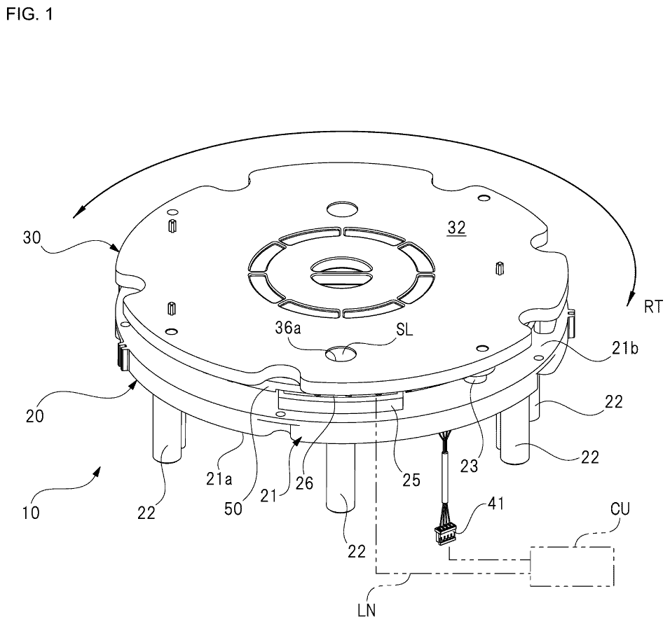

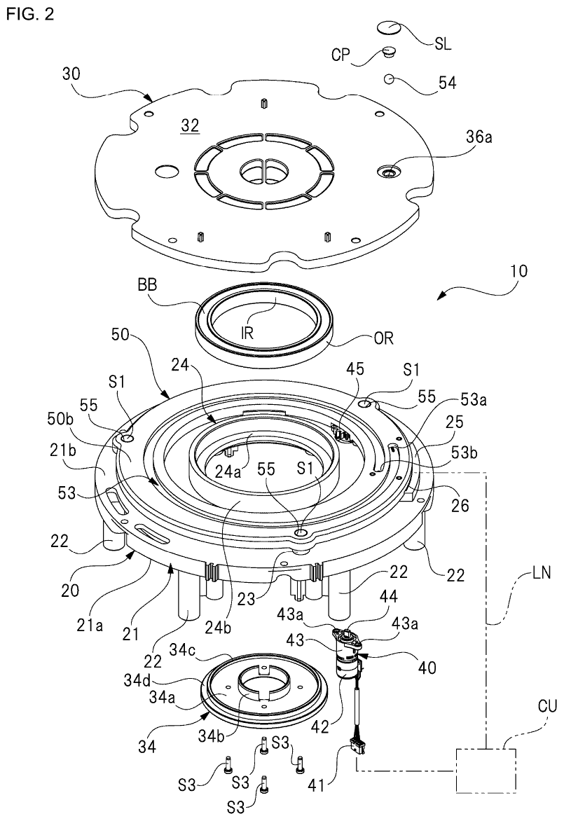

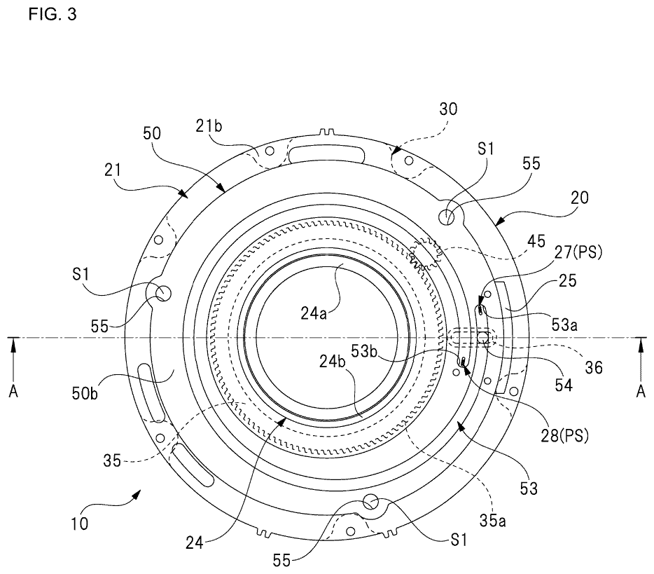

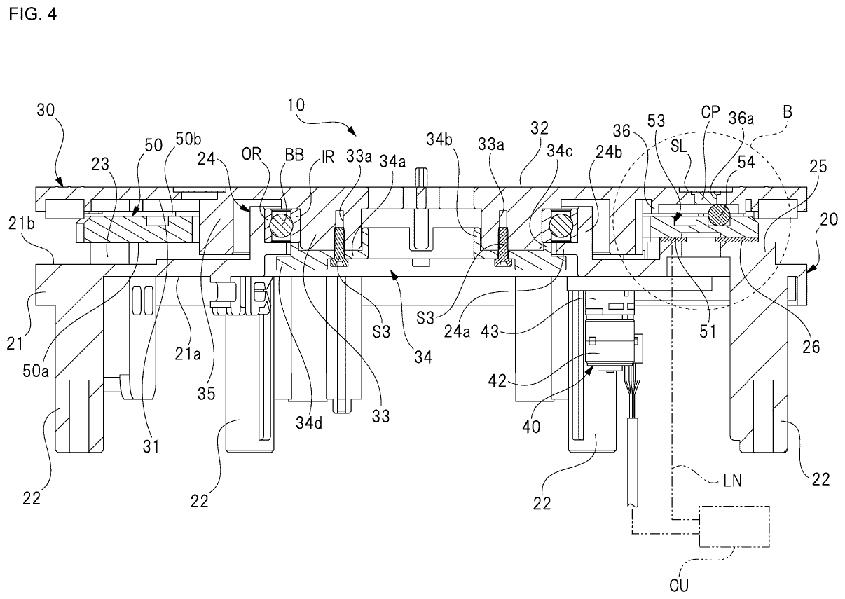

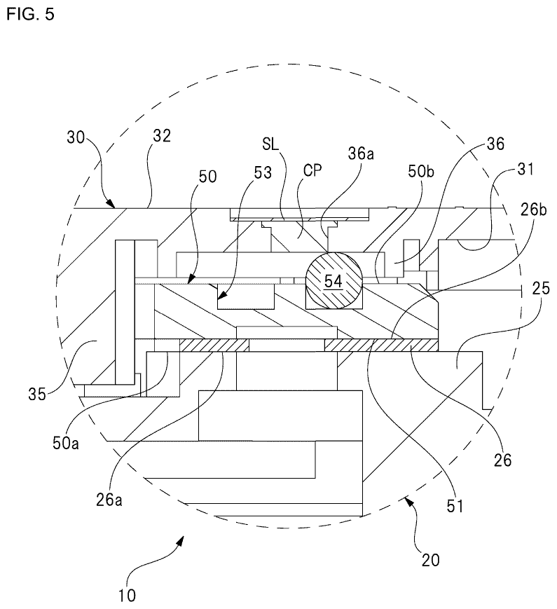

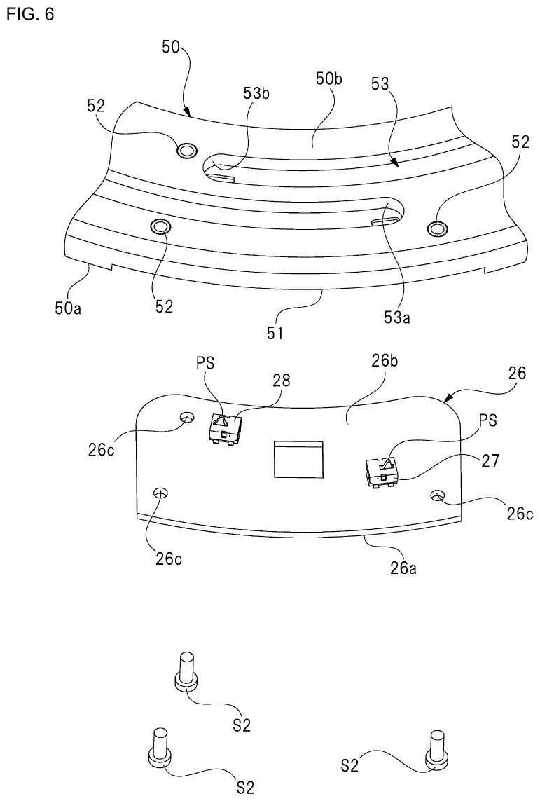

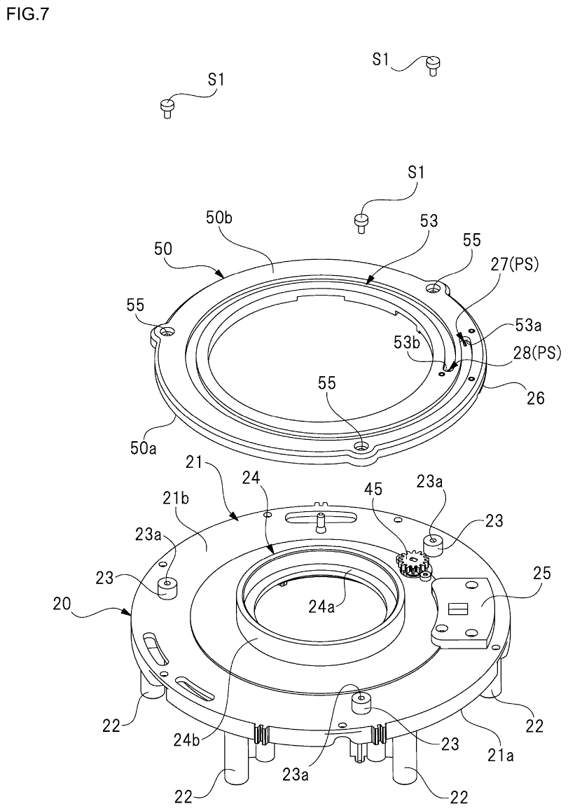

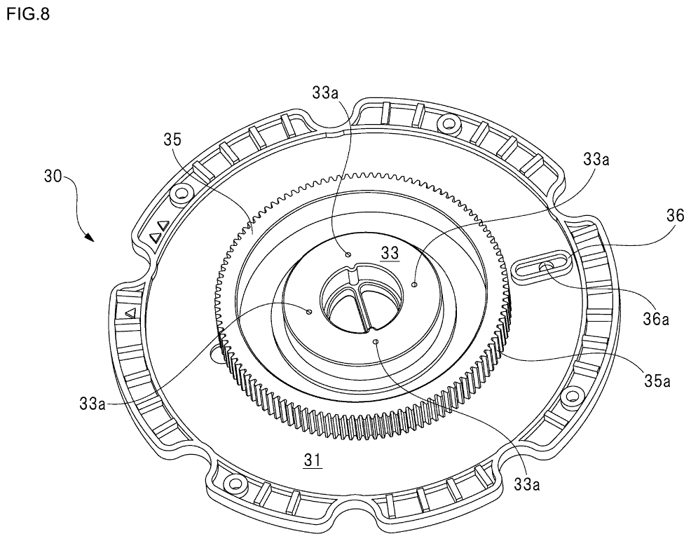

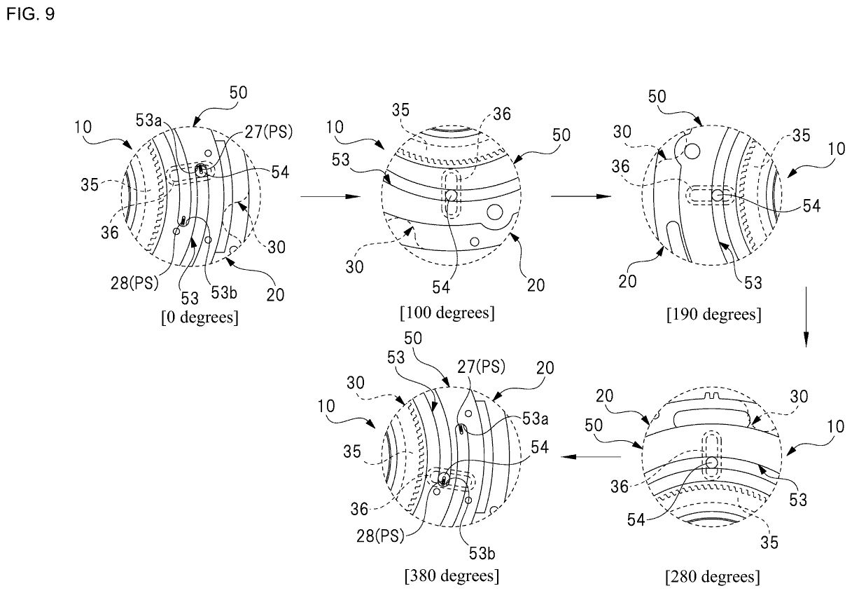

FIG. 1 is a perspective view of a rotary actuator according to a first embodiment. FIG. 2 is an exploded perspective view of the rotary actuator in FIG. 1. FIG. 3 is a plan view of the rotary actuator in FIG. 1 as viewed from a rotary member (dashed line). FIG. 4 is a cross-sectional view taken along line A-A in FIG. 3. FIG. 5 is an enlarged view of part B indicated by the dashed circle in FIG. 4. FIG. 6 is an exploded perspective view of a ring and a switch substrate. FIG. 7 is an exploded perspective view of a base and the ring. FIG. 8 is a perspective view of the rotary member as viewed from the base. FIG. 9 is a partially enlarged view of the rotary actuator in FIG. 1 describing the movement of a spherical member (at different angles).

### Overview of Rotary Actuator

As shown in FIGS. 1 and 2, a rotary actuator 10 is a substantially annular disk. The rotary actuator 10 is used as, for example, a drive source for rotating an antenna (not shown) that can receive millimeter waves to be directed toward a higher signal strength. The millimeter waves herein refer to radio waves suitable for high-speed and large-capacity communications with a wavelength of 1 to 10 millimeters and a frequency of 30 to 300 gigahertz.

The rotary actuator 10 includes a base 20 to be fastened to, for example, a floor surface or a support (not shown), and a rotary member 30 supported by the base 20 in a rotatable manner. The rotary actuator 10 includes a stepper motor 40 that rotates the rotary member 30. The stepper motor 40 is fastened to an end of the base 20 in a first axial direction (downward in the figures) of the base 20. The stepper motor 40 includes a connector 41 electrically connected to a control unit CU.

The stepper motor 40 corresponds to an electric motor in an aspect of the present invention.

### Stepper Motor

As shown in FIG. 2, the stepper motor 40 is substantially cylindrical. The stepper motor 40 includes a motor body 42 and a planetary gear reducer 43. The motor body 42 is located in a first axial direction (downward in the figure) of the stepper motor 40. The planetary gear reducer 43 is located in a second axial direction (upward in the figure) of the stepper motor 40. The planetary gear reducer 43 includes an output shaft 44, to which a pinion gear 45 is fixed.

The pinion gear 45 is thus driven to rotate at high torque in response to the motor body 42 being driven to rotate. The output shaft 44 to which the pinion gear 45 is fixed corresponds to a rotational shaft in an aspect of the present invention. The stepper motor 40 can accurately control the rotation angle and the rotational speed of the output shaft 44 based on pulse signals (square wave signals) from the control unit CU.

The planetary gear reducer 43 is integral with a pair of fixtures 43a. The fixtures 43a are fastened to a first surface 21a (refer to FIG. 4) of the base 20 with a pair of motor fastening screws (not shown). In other words, the stepper motor 40 is securely fastened to a portion of the base 20 opposite to the rotary member 30 with the pair of motor fastening screws.

### Base

As shown in FIGS. 1 to 4 and 7, the base 20 is substantially annular and is formed from a resin material such as plastic. The base 20 includes an annular body 21 and multiple fixed legs 22. The annular body 21 has the first surface 21a and a second surface 21b. More specifically, the first surface 21a is located in a first axial direction of the rotary actuator 10 (adjacent to the stepper motor 40) and extends in a direction perpendicular to the axial direction of the rotary actuator 10. The second surface 21b is located in a second axial direction (adjacent to the rotary member 30) of the rotary actuator 10 and extends in the direction perpendicular to the axial direction of the rotary actuator 10.

The fixed legs 22 have basal ends integral with the first surface 21a of the base 20. More specifically, the fixed legs 22 extend in the first axial direction of the rotary actuator 10. The fixed legs 22 have distal ends fastened to, for example, the floor surface or the support (not shown) with base fastening screws (not shown).

The stepper motor 40 is fastened to the first surface 21a of the base 20. The output shaft 44 included in the stepper motor 40 has a distal end extending through the annular body 21 of the base 20 and beyond the second surface 21b of the annular body 21. The pinion gear 45 is fixed to the output shaft 44 on the second surface 21b. In other words, the pinion gear 45 is rotatable by the stepper motor 40 on the second surface 21b.

The base 20 is integral with three bosses 23 located on a radially outer portion of the second surface 21b. The bosses 23 protrude by a predetermined height in a second axial direction of the base 20 (toward the rotary member 30), and are substantially cylindrical. The three bosses 23 are arranged at equal intervals (120 degrees) in the circumferential direction of the annular body 21. Each boss 23 has an internal thread 23a. A ring fastening screw S1 (refer to FIG. 7) for fastening a ring 50 to the second surface 21b of the annular body 21 is screwed into each internal thread 23a.

The base 20 is integral with an annular bearing holder 24 located on a radially inner portion of the base 20 and on the second surface 21b. The bearing holder 24 receives a ball bearing BB (refer to FIGS. 2 and 4) that supports the rotary member 30 in a rotatable manner. More specifically, the bearing holder 24 has a substantially L-shaped cross section and has an annular bottom wall 24a and an annular side wall 24b. The annular bottom wall 24a supports an outer race OR of the ball bearing BB in the axial direction. The annular side wall 24b supports the outer race OR of the ball bearing BB in the radial direction.

The ball bearing BB includes an inner race IR attached to a bearing attachment 33 in the rotary member 30. The inner race IR of the ball bearing BB is held between the rotary member 30 and a retainer 34. The annular bottom wall 24a of the bearing holder 24 is between the outer race OR of the ball bearing BB and the retainer 34. The rotary member 30 can thus rotate smoothly relative to the base 20 without separating from the base 20.

The base 20 is integral with a substrate support 25 located on the second surface 21b and adjacent to the pinion gear 45 (stepper motor 40). The substrate support 25 is substantially rectangular in a plan view, and protrudes from the second surface 21b by a predetermined height in the second axial direction of the base 20. As shown in FIG. 4, a switch substrate 26 fixed to the ring 50 is located on the substrate support 25.

### Ring

As shown in FIGS. 2 to 7, the ring 50 is mounted on the second surface 21b of the base 20. In other words, the ring 50 is a part of the base 20 and is a substantially flat plate formed from a resin material such as plastic. The ring 50 has a first ring surface 50a that is a first surface (a lower portion of the ring 50 in FIG. 6) of the ring 50 and a second ring surface 50b that is a second surface (an upper portion of the ring 50 in FIG. 6) of the ring 50.

The ring 50 has, on the first ring surface 50a, a substrate fastening recess 51 to which the switch substrate 26 is fastened. The substrate fastening recess 51 is recessed toward the second ring surface 50b of the ring 50 by a predetermined depth. The ring 50 includes, in a portion corresponding to the substrate fastening recess 51, three internally threaded portions 52 formed by, for example, insert molding.

Each internally threaded portion 52 is formed from a metal and is substantially cylindrical. A substrate fastening screw S2 for fastening the switch substrate 26 to the substrate fastening recess 51 is screwed into each internally threaded portion 52. The switch substrate 26 is thus supported at three points relative to the ring 50 and securely fastened to the ring 50.

As shown in FIG. 6, the ring 50 has, on the second ring surface 50b, a groove 53 in a substantially spiral shape when the base 20 (ring 50) is viewed from a position in the second axial direction of the base 20 (upward in FIG. 7). In other words, the groove 53 is on a facing portion (second ring surface 50b) of the ring 50, which is a part of the base 20, facing the rotary member 30.

The groove 53 is recessed toward the first ring surface 50a of the ring 50 by a predetermined depth. The groove 53 receives substantially a half of a spherical member 54 in a movable manner (refer to FIG. 5). The spherical member 54 rolls in the groove 53 in response to the rotary member 30 rotating relative to the base 20.

The spherical member 54 is formed from a metal (a steel). The spherical member 54 corresponds to a piece in an aspect of the present invention.

The groove 53 spirally extends in the circumferential direction of the ring 50, or in other words, in the rotation direction of the rotary member 30. The groove 53 extends for a range of about 380 degrees in the circumferential direction of the ring 50. More specifically, in response to the rotary member 30 rotating relative to the base 20, the spherical member 54 can move from a position adjacent to a first longitudinal end (refer to the state at 0 degrees in FIG. 9) of the groove 53 to a position adjacent to a second longitudinal end (refer to the state at 380 degrees in FIG. 9) of the groove 53. The rotary member 30 is thus rotatable within a range of rotation angles of greater than or equal to 360 degrees (about 380 degrees) relative to the base 20.

The groove 53 has a first groove end wall 53a at the first longitudinal end, or adjacent to a position of 0 degrees (refer to FIG. 9) that is a reference rotation angle position of the rotary member 30 relative to the base 20. The first groove end wall 53a defines a first movable end for the spherical member 54. The groove 53 has a second groove end wall 53b at the second longitudinal end, or adjacent to a position of 380 degrees (refer to FIG. 9) that is a maximum rotation angle position of the rotary member 30 relative to the base 20. The second groove end wall 53b defines a second movable end for the spherical member 54.

The first groove end wall 53a and the second groove end wall 53b are at the two longitudinal ends of the groove 53, and have substantially the same curvature as the spherical member 54. Thus, the spherical member 54 can come in contact with the first groove end wall 53a and the second groove end wall 53b in response to the rotary member 30 rotating relative to the base 20. The first groove end wall 53a and the second groove end wall 53b each correspond to a contact wall in an aspect of the present invention.

The ring 50 further has three screw receiving holes 55 extending through the ring 50 in the axial direction of the ring 50. More specifically, the screw receiving holes 55 are arranged at equal intervals (120 degrees) in the circumferential direction of the ring 50. The ring fastening screws S1 are received and tightened in the respective screw receiving holes 55. The ring 50 is thus securely fastened to the three bosses 23 on the second surface 21b of the base 20.

As shown in FIG. 2, with the ring 50 fastened to the base 20, the pinion gear 45 is partially exposed on the radially inner surface of the ring 50. The pinion gear 45 thus meshes with a cylindrical larger-diameter gear 35 in the rotary member 30 located between the bearing holder 24 and the ring 50 in the radial direction of the rotary actuator 10 as shown in FIG. 3.

### Switch Substrate

As shown in FIGS. 5 and 6, the switch substrate 26 fastened to the substrate fastening recess 51 on the ring 50 is a substantially rectangular printed circuit board (PCB) having a first substrate surface 26a and a second substrate surface 26b. In the assembled rotary actuator 10, the first substrate surface 26a is in contact with the substrate support 25 in the base 20, and the second substrate surface 26b is in contact with the substrate fastening recess 51 on the ring 50.

A first detection switch 27 and a second detection switch 28 are mounted on the second substrate surface 26b of the switch substrate 26. Each of the first and second detection switches 27 and 28 is operable by the spherical member 54 and is a limit switch. More specifically, the first and second detection switches 27 and 28 each include a press portion PS that can be pressed by the spherical member 54. When the press portion PS is pressed by the spherical member 54, the first or second detection switch 27 or 28 outputs an on-signal.

As shown in FIGS. 1, 2, and 4, the switch substrate 26 is electrically connected to the control unit CU with substrate wiring LN. This allows the control unit CU to determine the states of the first and second detection switches 27 and 28 operated by the spherical member 54 and accurately control the rotation angle of the stepper motor 40.

More specifically, in the assembled rotary actuator 10, the press portion PS in the first detection switch 27 is exposed in front of the first groove end wall 53a of the groove 53 as shown in FIG. 3. In other words, the spherical member 54 moving in the groove 53 can operate the press portion PS in the first detection switch 27 before coming in contact with the first groove end wall 53a.

In the assembled rotary actuator 10, the press portion PS in the second detection switch 28 is exposed in front of the second groove end wall 53b of the groove 53. In other words, the spherical member 54 moving in the groove 53 can operate the press portion PS in the second detection switch 28 before coming in contact with the second groove end wall 53b.

As described above, the first and second detection switches 27 and 28 operable by the spherical member 54 are located adjacent to the two longitudinal ends of the groove 53. The first and second detection switches 27 and 28 each correspond to a rotation detection switch in an aspect of the present invention.

In this structure, the control unit CU can determine that the spherical member 54 has operated the press portion PS in the first detection switch 27, or in other words, the rotary member 30 is at the reference rotation angle position of 0 degrees relative to the base 20. Based on this determination, the control unit CU can accurately control the rotation of the stepper motor 40 in a direction to add (increase) the rotation angle.

The control unit CU can determine that the spherical member 54 has operated the press portion PS in the second detection switch 28, or in other words, the rotary member 30 is at the maximum rotation angle position of 380 degrees relative to the base 20. Based on this determination, the control unit CU can accurately control the rotation of the stepper motor 40 in a direction to subtract (decrease) the rotation angle.

The control unit CU can thus cause the rotary member 30 to rotate relative to the base 20 periodically, and the spherical member 54 to press the first detection switch 27 or the second detection switch 28 to automatically correct the angle position of the stepper motor 40 to a normal position. This correction operation is an automatic maintenance operation automatically performed by the control unit CU through programming. This saves time and effort for a user.

The control unit CU includes a memory (not shown), such as a random-access memory (RAM). The memory stores the rotation angles of the output shaft 44 (refer to FIG. 2) in the stepper motor 40 and the rotation angles of the rotary member 30 relative to the base 20 associated with each other. The control unit CU can thus accurately increase the rotation angle from the angle position of 0 degrees or decrease the rotation angle from the angle position of 380 degrees.

The rotation angles of the output shaft 44 in the stepper motor 40 and the rotation angles of the rotary member 30 relative to the base 20 are associated with each other based on, for example, the gear ratio (deceleration ratio) between the pinion gear 45 and the cylindrical larger-diameter gear 35.

The first and second detection switches 27 and 28 are mechanical switches operable by the spherical member 54. The switches can thus output on-signals and off-signals more reliably than contactless switches such as magnetic sensors or optical sensors.

For example, when the control unit CU malfunctions due to, for example, overheating and fails to detect the on-signals and the off-signals from the first and second detection switches 27 and 28, the spherical member 54 moves, in the groove 53, between the first groove end wall 53a and the second groove end wall 53b in response to the rotary member 30 rotating relative to the base 20. The spherical member 54 comes in contact with the first groove end wall 53a or the second groove end wall 53b, thus preventing the rotary member 30 from rotating by a rotation angle greater than or equal to the predetermined rotation angle relative to the base 20 (fail-safe operation).

The rotation of the rotary member 30 relative to the base 20 will be described in detail later.

As shown in FIG. 6, the switch substrate 26 has three screw insertion holes 26c. The screw insertion holes 26c extend through the switch substrate 26 in the thickness direction of the switch substrate 26. Each screw insertion hole 26c receives the corresponding substrate fastening screw S2.

### Rotary Member

As shown in FIGS. 1 to 5 and 8, the rotary member 30 is a substantially disk-shaped and is formed from a resin material such as plastic. The rotary member 30 has a rear surface 31 and a front surface 32. More specifically, the rear surface 31 is located in the first axial direction (adjacent to the base 20) of the rotary actuator 10 and extends in the direction perpendicular to the axial direction of the rotary actuator 10. The front surface 32 is located in the second axial direction (opposite to the base 20) of the rotary actuator 10 and extends in the direction perpendicular to the axial direction of the rotary actuator 10.

As shown in FIGS. 4 and 8, the rotary member 30 is integral with the bearing attachment 33 located radially inward from the rear surface 31. The bearing attachment 33 is thick and substantially cylindrical. The bearing attachment 33 includes a radially outer portion to which the inner race IR of the ball bearing BB is attached. The inner race IR attached to the bearing attachment 33 has an end in its second axial direction in contact with the rotary member 30.

The bearing attachment 33 has four internally threaded holes 33a located in its first axial direction (downward in FIG. 4). The internally threaded holes 33a are arranged at equal intervals (90 degrees) in the circumferential direction of the bearing attachment 33. Externally threaded members S3 for fastening the retainer 34 (refer to FIGS. 2 and 4) to the rotary member 30 are screwed into the respective internally threaded holes 33a.

The retainer 34 prevents the ball bearing BB from slipping off the bearing attachment 33 and prevents the rotary member 30 from separating from the base 20. The retainer 34 is substantially disk-shaped and is formed from a resin material such as plastic.

As shown in FIG. 4, the retainer 34 includes a body 34a, a smaller-diameter cylindrical portion 34b, a larger-diameter cylindrical portion 34c, and a flange 34d. The externally threaded members S3 are placed through the body 34a. The smaller-diameter cylindrical portion 34b is integral with a radially inner portion of the body 34a and protrudes toward the rotary member 30. The larger-diameter cylindrical portion 34c is integral with a radially outer portion of the body 34a and protrudes toward the rotary member 30. The flange 34d is located outward from the larger-diameter cylindrical portion 34c in the radial direction of the body 34a.

The smaller-diameter cylindrical portion 34b radially inward from the bearing attachment 33 is placed from a position in the first axial direction of the bearing attachment 33. The larger-diameter cylindrical portion 34c, which has a larger diameter than the smaller-diameter cylindrical portion 34b, supports an end of the inner race IR in a first axial direction of the inner race IR attached to the bearing attachment 33. The inner race IR of the ball bearing BB is thus held between the rotary member 30 and the retainer 34 with the externally threaded members S3 fastened tightly.

The flange 34d protrudes outward in the radial direction of the retainer 34 and faces the annular bottom wall 24a in the axial direction of the rotary member 30. More specifically, the flange 34d is located in a first axial direction of the rotary member 30, and the annular bottom wall 24a is located in a second axial direction of the rotary member 30. The annular bottom wall 24a is thus located between the flange 34d and the outer race OR of the ball bearing BB. This prevents the rotary member 30 from separating from the base 20.

As shown in FIG. 8, the rotary member 30 is, on the rear surface 31 of the rotary member 30, integral with the cylindrical larger-diameter gear 35 located radially outward from the bearing attachment 33. The cylindrical larger-diameter gear 35 has, on its outer circumference, multiple gear teeth 35a that mesh with the pinion gear 45 (refer to FIG. 7). The gear teeth 35a has more teeth than the pinion gear 45. This allows the cylindrical larger-diameter gear 35 to rotate at a lower speed and at higher torque than the pinion gear 45.

The pinion gear 45 and the cylindrical larger-diameter gear 35 thus together serve as a reducer. The bearing holder 24 and the ball bearing BB are located radially inward from the cylindrical larger-diameter gear 35 in the radial direction of the rotary actuator 10.

As shown in FIG. 8, the rotary member 30 is integral with a sphere holder 36 located radially outward from the larger-diameter gear 35. The sphere holder 36 is a substantially oval protrusion. The sphere holder 36 protrudes in the first axial direction of the rotary member 30 by a predetermined height and extends in the radial direction of the rotary member 30. The sphere holder 36 receives substantially a half of the spherical member 54 in a movable manner (refer to FIG. 5). More specifically, the spherical member 54 is held by the sphere holder 36 and is on a facing portion (rear surface 31) of the rotary member 30 facing the base 20.

The sphere holder 36 is on a facing portion (rear surface 31) of the rotary member 30 facing the groove 53, extends in the radial direction of the rotary member 30, and holds the spherical member 54 in a movable manner. The sphere holder 36 corresponds to a holding groove in an aspect of the present invention.

More specifically, the sphere holder 36 holds the spherical member 54 in a movable manner relative to the rotary member 30 in the radial direction of the rotary member 30 alone. In other words, the spherical member 54 is movable relative to the rotary member 30 in the radial direction of the rotary member 30 alone, and is immovable in the circumferential direction of the rotary member 30. Thus, in response to the rotary member 30 rotating relative to the base 20, the spherical member 54 moves together with the rotary member 30 and also rolls in the groove 53. The spherical member 54 moves in the sphere holder 36 while moving in the substantially spiral groove 53.

The rotary member 30 has a through-hole 36a in a portion corresponding to the inner space of the sphere holder 36. The through-hole 36a extends through the rotary member 30 in the axial direction of the rotary member 30. The through-hole 36a is for placing the spherical member 54 between the groove 53 and the sphere holder 36 with the rotary member 30 joined to the base 20. The through-hole 36a receives a cap CP. The cap CP is covered with a seal SL.

### Operation of Rotary Actuator

An example operation of the rotary actuator 10 with the above structure will now be described in detail with reference to FIG. 9.

First, as shown in the dashed circle labeled with 0 degrees in FIG. 9, the rotary member 30 in the rotary actuator 10 is stopped at the reference rotation angle position of 0 degrees relative to the base 20. In this state, the spherical member 54 is located slightly in front of the first groove end wall 53a and pressing the press portion PS in the first detection switch 27. The spherical member 54 in this state is located outward in the radial direction in the sphere holder 36. In other words, the first groove end wall 53a of the substantially spiral groove 53 is located outward from the second groove end wall 53b in the radial direction of the ring 50.

Subsequently, the control unit CU controls the rotation of the stepper motor 40 to rotate the rotary member 30 clockwise relative to the base 20. When the rotary member 30 is rotated in the direction to add the rotation angle from the rotation angle position of 0 to 100 degrees, the rotary member 30 is in the state shown in the dashed circle labeled with 100 degrees in FIG. 9. More specifically, the spherical member 54 moves together with the rotary member 30 and rolls in the groove 53. The spherical member 54 also moves to, relative to the sphere holder 36, substantially the middle of the sphere holder 36 in the longitudinal direction.

Subsequently, the control unit CU further controls the rotation of the stepper motor 40 to rotate the rotary member 30 clockwise relative to the base 20. When the rotary member 30 is rotated in the direction to add the rotation angle from the rotation angle position of 100 to 190 degrees, the rotary member 30 is in the state shown in the dashed circle labeled with 190 degrees in FIG. 9. In other words, the spherical member 54 further moves together with the rotary member 30 and rolls in the groove 53 further. The spherical member 54 moves closer to the larger-diameter gear 35 than substantially the middle of the sphere holder 36 in the longitudinal direction in the sphere holder 36.

Subsequently, the control unit CU further controls the rotation of the stepper motor 40 to rotate the rotary member 30 clockwise relative to the base 20. When the rotary member 30 is rotated in the direction to add the rotation angle from the rotation angle position of 190 to 280 degrees, the rotary member 30 is in the state shown in the dashed circle labeled with 280 degrees in FIG. 9. In other words, the spherical member 54 further moves together with the rotary member 30 and rolls in the groove 53 further. The spherical member 54 moves much closer to the larger-diameter gear 35 than in the state at 190 degrees described above in the sphere holder 36.

Subsequently, the control unit CU further controls the rotation of the stepper motor 40 to rotate the rotary member 30 clockwise relative to the base 20. When the rotary member 30 is rotated in the direction to add the rotation angle from the rotation angle position of 280 to 380 degrees, the rotary member 30 is in the state shown in the dashed circle labeled with 380 degrees in FIG. 9. In other words, the spherical member 54 further moves together with the rotary member 30 and rolls in the groove 53 further. The spherical member 54 moves much closer to the larger-diameter gear 35 than in the state at 280 degrees described above in the sphere holder 36.

Upon receiving an on-signal after the spherical member 54 presses the press portion PS in the second detection switch 28, the control unit CU stops controlling the rotation of the stepper motor 40. The rotary member 30 is thus stopped at the maximum rotation angle position of 380 degrees relative to the base 20.

In this manner, the control unit CU can control the rotation of the rotary member 30 relative to the base 20 within the range of angles from 0 to 380 degrees. The control unit CU increases the rotation angle from the angle position of 0 degrees or decreases the rotation angle from the angle position of 380 degrees to control the rotation angle of the rotary member 30 relative to the base 20 as appropriate. The rotary actuator 10 may thus be used as, for example, a drive source for rotating the antenna that can receive millimeter waves to be directed toward a higher signal strength.

As described in detail above, the rotary actuator 10 according to the first embodiment includes the groove 53 located on the second ring surface 50b, which is the facing portion of the base 20 facing the rotary member 30, and extending in the rotation direction of the rotary member 30, the spherical member 54 located on the rear surface 31, which is the facing portion of the rotary member 30 facing the base 20, and movable in the groove 53 in response to the rotary member 30 rotating relative to the base 20, and the first and second detection switches 27 and 28 located adjacent to the two longitudinal ends of the groove 53 and operable by the spherical member 54.

In this structure, the control unit CU can determine that the spherical member 54 has operated the press portion PS in the first detection switch 27, or in other words, the rotary member 30 is at the reference rotation angle position of 0 degrees relative to the base 20. Based on this determination, the control unit CU can accurately control the rotation of the stepper motor 40 in the direction to add (increase) the rotation angle. The control unit CU can determine that the spherical member 54 has operated the press portion PS in the second detection switch 28, or in other words, the rotary member 30 is at the maximum rotation angle position of 380 degrees relative to the base 20. Based on this determination, the control unit CU can accurately control the rotation of the stepper motor 40 in the direction to subtract (decrease) the rotation angle.

The control unit CU can thus cause the rotary member 30 to rotate relative to the base 20 periodically, and the spherical member 54 to press the first detection switch 27 or the second detection switch 28 to correct the angle position of the stepper motor 40 to the normal position. The rotary actuator 10 thus has high maintainability.

In the rotary actuator 10 according to the first embodiment, the groove 53 is spiral when the base 20 is viewed in the axial direction, and the spherical member 54 is movable relative to the rotary member 30 in the radial direction of the rotary member 30 alone.

Thus, in response to the rotary member 30 rotating relative to the base 20, the spherical member 54 moves together with the rotary member 30 and rolls in the groove 53 on the base 20. This allows the rotary member 30 to rotate relative to the base 20 within the range of angles (range of predetermined angles) of the substantially spiral groove 53.

The rotary actuator 10 according to the first embodiment further includes, on the rear surface 31 that is the facing portion of the rotary member 30 facing the groove 53, the sphere holder 36 extending in the radial direction of the rotary member 30 and holding the spherical member 54 in a movable manner.

This allows the spherical member 54 to roll in the substantially spiral groove 53 and also to move relative to the rotary member 30 in the radial direction of the rotary member 30.

In the rotary actuator 10 according to the first embodiment, the groove 53 has, at its two longitudinal ends, the first groove end wall 53a and the second groove end wall 53b, and the spherical member 54 can come in contact with the first groove end wall 53a and the second groove end wall 53b in response to the rotary member 30 rotating relative to the base 20.

Thus, for example, when the control unit CU malfunctions due to, for example, overheating and fails to detect the on-signals and the off-signals from the first and second detection switches 27 and 28, the spherical member 54 moves, in the groove 53, between the first groove end wall 53a and the second groove end wall 53b in response to the rotary member 30 rotating relative to the base 20. This prevents the rotary member 30 from rotating by a rotation angle greater than or equal to the predetermined rotation angle relative to the base 20 (fail-safe operation).

In the rotary actuator 10 according to the first embodiment, the spherical member 54 can operate the first and second detection switches 27 and 28 before coming in contact with the first groove end wall 53a and the second groove end wall 53b.

This allows the control unit CU to control (stop or reverse) the stepper motor 40 before the spherical member 54 comes in contact with the first groove end wall 53a and the second groove end wall 53b. This prevents the spherical member 54 and the groove 53 from being damaged.

The rotary actuator 10 according to the first embodiment includes the spherical member 54 rollable in the groove 53. The spherical member 54 can thus roll in the groove 53 and the sphere holder 36. The rotary actuator 10 with this structure can avoid an increase in the rotational resistance of the rotary member 30 relative to the base 20, and may thus include a smaller stepper motor 40 as its drive source.

The rotary actuator 10 according to the first embodiment includes, as its drive source, the stepper motor 40 that can control the rotation angle of the rotational shaft. This allows precise and accurate adjustment of the rotation angle position of the rotary member 30 relative to the base 20.

### Second Embodiment

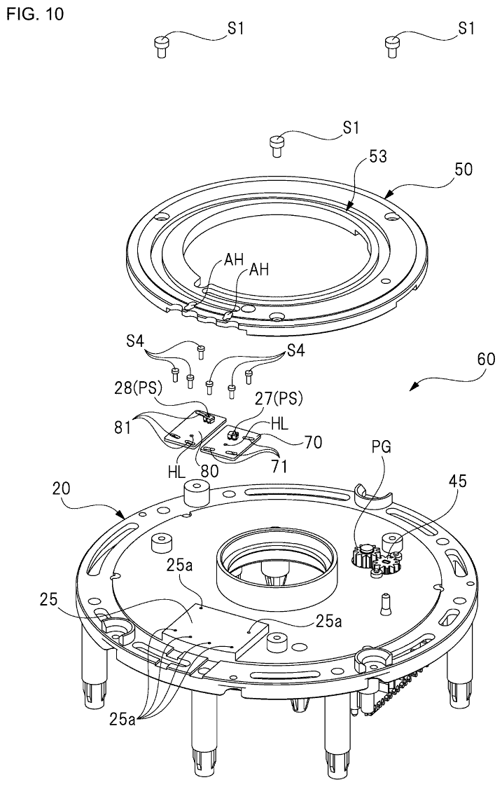

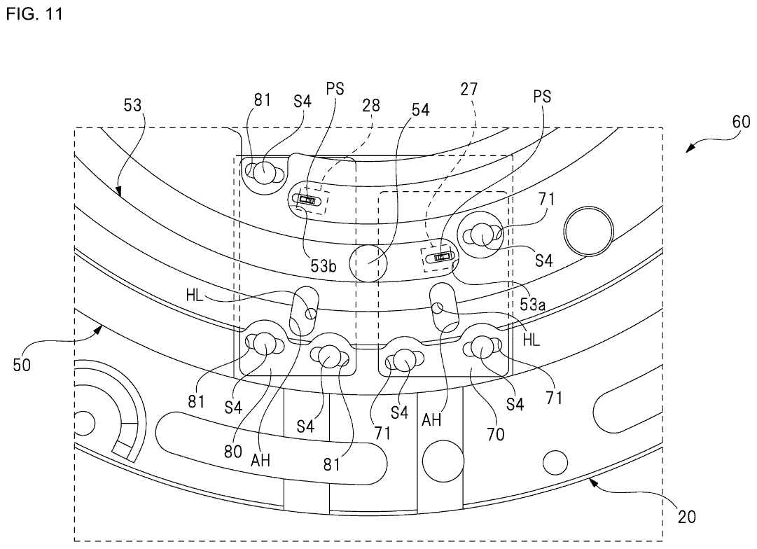

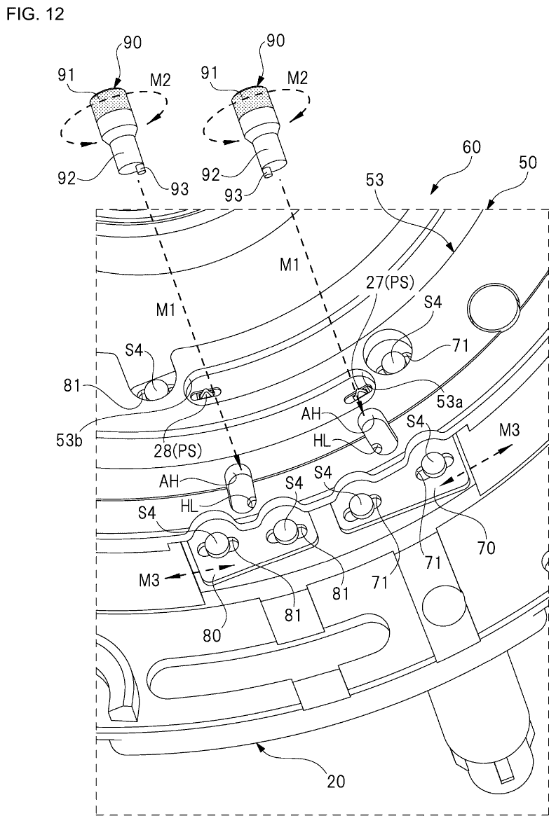

FIG. 10 is an exploded perspective view of a rotary actuator according to a second embodiment (with no rotary member shown). FIG. 11 is an enlarged plan view of portions corresponding to a first switch substrate and a second switch substrate in the rotary actuator in FIG. 10 (with no rotary member shown). FIG. 12 is an enlarged perspective view of the rotary member in FIG. 10 describing positional adjustment of the first switch substrate and the second switch substrate relative to the ring.

Like reference numerals denote like functional elements in the above first embodiment. Such elements will not be described in detail.

As shown in FIGS. 10 to 12, a rotary actuator 60 according to the second embodiment differs from the rotary actuator 10 according to the first embodiment in that the rotary actuator 60 includes a first switch substrate 70 and a second switch substrate 80 in a pair. The rotary actuator 60 according to the second embodiment also differs in that the first and second switch substrates 70 and 80 are each fastened to the substrate support 25 in the base 20 with three substrate fastening screws S4.

Further, the rotary actuator 60 according to the second embodiment differs in that the first and second switch substrates 70 and 80 each have a jig insertion hole HL for adjusting the positions of the first and second switch substrates 70 and 80 relative to the substrate support 25. The rotary actuator 60 according to the second embodiment also differs in that another pinion gear PG is located between the pinion gear 45 in the stepper motor 40 and the cylindrical larger-diameter gear 35 (refer to FIG. 8) in the rotary member 30.

More specifically, the first detection switch 27 is mounted on the first switch substrate 70. In other words, the first switch substrate 70 is located adjacent to the first groove end wall 53a. The second detection switch 28 is mounted on the second switch substrate 80. In other words, the second switch substrate 80 is located adjacent to the second groove end wall 53b.

The first detection switch 27 in the second embodiment is located adjacent to the first longitudinal end of the groove 53. The first detection switch 27 corresponds to the rotation detection switch and a first switch in an aspect of the present invention. The second detection switch 28 in the second embodiment is located adjacent to the second longitudinal end of the groove 53. The second detection switch 28 corresponds to the rotation detection switch and a second switch in an aspect of the present invention.

The first switch substrate 70 has three slits 71, and the second switch substrate 80 has three slits 81. The slits 71 and 81 receive the substrate fastening screws S4. In other words, with the substrate fastening screws S4 fastened temporarily, the first and second switch substrates 70 and 80 are movable relative to the substrate support 25. More specifically, with the substrate fastening screws S4 fastened temporarily, the first switch substrate 70 can move in a direction in which the slits 71 are elongated, and the second switch substrate 80 can move in a direction in which the slits 81 are elongated.

The substrate fastening screws S4 are screwed into internal threads 25a on the substrate support 25.

As shown in FIG. 11, the ring 50 in the rotary actuator 60 according to the second embodiment has a pair of adjustment holes AH that are substantially oval. One of the pair of first adjustment holes AH corresponds to the first switch substrate 70, and the other of the pair of adjustment holes AH corresponds to the second switch substrate 80. In the assembled rotary actuator 60, the jig insertion holes HL are inside the respective adjustment holes AH.

In the rotary actuator 60 according to the second embodiment, jigs 90 shown in FIG. 12 are used to adjust the positions of the first and second switch substrates 70 and 80 relative to the substrate support 25. More specifically, each jig 90 includes a knob 91 that is substantially a column with a step and has a larger diameter and a first insertion portion 92 having a smaller diameter than the knob 91. The knobs 91 are processed to have their outer peripheries knurled with a diamond pattern (shaded in the figure) for slip prevention.

A second insertion portion 93 having a smaller diameter than the first insertion portion 92 and being offset (decentered) from the central axis of the first insertion portion 92 is at the distal end (downward in FIG. 12) of each of the first insertion portions 92.

With the first and second switch substrates 70 and 80 temporarily fastened to the substrate support 25, the first insertion portions 92 are inserted into the respective adjustment holes AH in the ring 50 as indicated by dashed arrows M1 in FIG. 12. The second insertion portions 93 are then inserted into the respective jig insertion holes HL in the first and second switch substrates 70 and 80.

The jigs 90 are then rotated as indicated by dashed arrows M2. This causes the first and second switch substrates 70 and 80 to move (slide) relative to the substrate support 25 as indicated by dashed arrows M3. With the first and second switch substrates 70 and 80 positioned relative to the substrate support 25, the substrate fastening screws S4 are fully tightened to the respective internal threads 25a.

This allows the first and second switch substrates 70 and 80 to be positioned at any positions relative to the substrate support 25. Thus, the position of the first detection switch 27 relative to the groove 53 and the position of the second detection switch 28 relative to the groove 53 are adjusted individually. This adjusts the timing at which the spherical member 54 operates the first and second detection switches 27 and 28.

As described above in detail, the structure in the second embodiment also produces the same advantageous effects as in the first embodiment. In addition, in the second embodiment, the positions of the first and second detection switches 27 and 28 relative to the groove 53 can be adjusted, thus allowing adjustment of the range of rotation angles of the rotary member 30 relative to the base 20. The rotary actuator 60 according to the second embodiment can thus respond to a wider variety of requests.

The pinion gear PG is located between the pinion gear 45 and the cylindrical larger-diameter gear 35 (refer to FIG. 8) and meshes with the pinion gear 45 and the cylindrical larger-diameter gear 35, thus allowing adjustment of the deceleration ratio more precisely. Thus, for example, a smaller stepper motor 40 can be used.

The present invention is not limited to the above embodiments, but may be modified variously without departing from the spirit and scope of the invention. For example, although the rotary actuator 10 or 60 is used as a drive source for rotating the antenna that can receive millimeter waves to be directed toward a higher signal strength in the above embodiments, the present invention is not limited to the above embodiments. The rotary actuator 10 or 60 may also be used for other purposes, and in particular, for a driving target for which the rotation angle of the rotary member 30 relative to the base 20 is to be set precisely.

Although the spherical member 54 is used as the piece in the above embodiments, the present invention is not limited to the above embodiments, and the piece may be in any shape other than a spherical member, such as a quadrangular prism member or a polyhedral member.

Although the rotation detection switches are the limit switches (mechanical switches) each including the press portion PS in the above embodiments, the present invention is not limited to the above embodiments. The rotation detection switches may be other types of switches (e.g., contactless switches), such as magnetic switches or optical switches. For example, when the rotation detection switches are magnetic switches, the piece may be formed from a metal to allow the magnetic switches to detect the piece coming closer to the magnetic switches. When the rotation detection switches are optical switches, the optical switches may detect light that is emitted from the optical switches and is blocked by the piece.

The materials, shapes, dimensions, numbers, and positions of the components in the above embodiments may be determined as appropriate to achieve the aspects of the present invention without being limited to the above embodiments.

The technique according to one or more embodiments of the present invention may provide the structure described below.

(1) A rotary actuator, comprising:
a base;
a rotary member supported by the base in a rotatable manner;
an electric motor configured to rotate the rotary member;
a groove on a facing portion of the base, the facing portion facing the rotary member, the groove extending in a rotation direction of the rotary member;
a piece on a facing portion of the rotary member, the facing portion facing the base, the piece being movable in the groove in response to the rotary member rotating relative to the base; and
rotation detection switches located adjacent to two longitudinal ends of the groove, the rotation detection switches being operable by the piece.

(2) The rotary actuator according to (1), wherein
the groove is spiral when the base is viewed in an axial direction, and
the piece is movable relative to the rotary member in a radial direction of the rotary member.

(3) The rotary actuator according to (2), further comprising:
a holding groove on a facing portion of the rotary member, the facing portion facing the groove, the holding groove extending in the radial direction of the rotary member and holding the piece in a movable manner.

(4) The rotary actuator according to any one of (1) to (3), further comprising:
contact walls at two longitudinal ends of the groove, the piece being configured to come in contact with the contact walls in response to the rotary member rotating relative to the base.

(5) The rotary actuator according to (4), wherein
the piece is configured to operate the rotation detection switches before coming in contact with the contact walls.

(6) The rotary actuator according to any one of (1) to (5), wherein
the piece is a spherical member rollable in the groove.

(7) The rotary actuator according to any one of (1) to (6), wherein
the electric motor is a stepper motor configured to control a rotation angle of a rotational shaft.

(8) The rotary actuator according to any one of (1) to (7), wherein
the rotation detection switches include a first switch located adjacent to a first longitudinal end of the groove and a second switch located adjacent to a second longitudinal end of the groove, and
a position of the first switch relative to the groove and a position of the second switch relative to the groove are adjustable individually.

What is claimed is:

1. A rotary actuator, comprising:
a base;
a rotary member supported by the base in a rotatable manner;
an electric motor configured to rotate the rotary member;
a groove on a facing portion of the base, the facing portion facing the rotary member, the groove extending in a rotation direction of the rotary member;
a piece on a facing portion of the rotary member, the facing portion facing the base, the piece being movable in the groove in response to the rotary member rotating relative to the base; and
rotation detection switches located adjacent to two longitudinal ends of the groove, the rotation detection switches being operable by the piece.

2. The rotary actuator according to claim 1, wherein
the groove is spiral when the base is viewed in an axial direction, and
the piece is movable relative to the rotary member in a radial direction of the rotary member.

3. The rotary actuator according to claim 2, further comprising:
a holding groove on a facing portion of the rotary member, the facing portion facing the groove, the holding groove extending in the radial direction of the rotary member and holding the piece in a movable manner.

4. The rotary actuator according to claim 1, further comprising:
contact walls at two longitudinal ends of the groove, the piece being configured to come in contact with the contact walls in response to the rotary member rotating relative to the base.

5. The rotary actuator according to claim 4, wherein
the piece is configured to operate the rotation detection switches before coming in contact with the contact walls.

6. The rotary actuator according to claim 1, wherein
the piece is a spherical member rollable in the groove.

7. The rotary actuator according to claim 1, wherein
the electric motor is a stepper motor configured to control a rotation angle of a rotational shaft.

8. The rotary actuator according to claim 1, wherein
the rotation detection switches include a first switch located adjacent to a first longitudinal end of the groove and a second switch located adjacent to a second longitudinal end of the groove, and
a position of the first switch relative to the groove and a position of the second switch relative to the groove are adjustable individually.
